(19) United States
(12) Patent Application Publication
(10) Pub. No.: US 2001/0011853 A1
(43) Pub. Date: Aug. 9, 2001

(54) C-FRAME MOTOR DESIGN AND METHOD

(76) Inventors: WILLIAM S GATLEY, CASSVILLE, MO (US); BOBBY D GARRISON, CASSVILLE, MO (US)

Correspondence Address: TERRENCE (TERY ) MARTIN, INVENSYS- INTELLECTUAL PROPERTY DEPARTMENT, 33 COMMERCIAL STREET, B52-1J, FOXBORO, MA, 02035, US

(21) Appl. No.: 09/426,380

(22) Filed: Oct. 25, 1999

Related U.S. Application Data
(60) Provisional application No. 60/105,679, filed on Oct. 26, 1998.

(51) Int. Cl. H02K 5/00; H02K 1/12

(52) U.S. Cl. 310/254; 310/261; 310/89

(57) ABSTRACT

A C-frame motor comprising a stator, a rotor, a rotor shaft, a bobbin and a housing is disclosed. The housing is configured to conform to the shape of the stator/rotor/bobbin assembly so that a curtain of air can be concentrated onto the motor to enhance performance, safety and motor longevity.

### CROSS REFERENCE TO RELATED APPLICATION

The present application claims the benefit of Provisional Application Ser. No. 60/105,679 filed Oct. 26, 1998, the teachings of which are incorporated by reference.

### BACKGROUND OF THE INVENTION

1. Field of the Invention

The disclosed invention relates generally to electric motors. More specifically, the invention relates to C-frame or bobbin-type motors.

2. Description of the Related Art

Of the wide variety of electric motors available today, one of the more common but unique varieties is the type known as a C-frame or bobbin-type electric motor. A conventional electric motor is structured to have a rotor surrounded by a stator with windings. The process of applying windings to a stator requires sophisticated expensive equipment in order to place the windings in a proper configuration to ensure proper motor function.

In contrast, the C-frame type motor does not utilize windings on the stator. Instead, the windings are wound onto a bobbin in similar fashion to how a thread is wound onto a bobbin. The bobbin/windings sub-assembly is then attached to the stator. The phase shift required to start an electric motor is accomplished by the C-frame motor by virtue of the eccentric, asymmetrical orientation of the windings relative to the stator poles or by the addition of shading coils.

One of the main problems with C-frame motors is their open design. To date, C-frame motors have been designed without any motor housing and are typically known as open skeleton construction designs. The absence of a housing is primarily due to the asymmetrical shape of the C-frame motor. Without the presence of a housing, a number of problems are inherent when a C-frame motor is used.

One of the main problems with C-frame motors is safety. Open skeleton construction motors are very hot to the touch. Thus, any servicing of such a motor requires a cool down period. Furthermore, in the typical furnace application, the localized heat buildup can affect the relatively sensitive windings.

An additional problem is efficiency. Without a motor housing, any air that is passed over the motor to cool the motor via an attached impeller cannot be focused onto the motor parts since there is no impediment to prevent the air from dispersing. This inevitably leads to inefficient cooling. Inefficient cooling reduces motor life and limits the capacity for developing stronger C-frame type motors.

A further problem is the potential buildup of foreign particles, e.g., dust, on the various motor components. Without a protective housing, dust particles can lodge within the motor interstices which can lead to reduced power output as well as damage to the motor over time.

It is thus an object of the invention to provide a C-frame motor design that eliminates the safety hazards that are inherent in present C-frame motor designs. Another object of the invention is to increase motor cooling efficiency by preventing air being directed over the motor by an attached impeller from dispersing.

A further object of the invention is to improve motor longevity by lowering the operating temperature of any given C-frame motor size.

A still further object of the invention with respect to at least one embodiment having a vent-less end-cap is to reduce or eliminate the buildup of dust particles on the components of C-frame motors.

A yet additional object of the invention is to facilitate the ability to design stronger C-frame motors within the same size constraints as relatively weaker motors. A yet further object of the invention is to improve the appearance of C-frame motors and to improve manufacturability.

### SUMMARY OF THE INVENTION

The invention accomplishes the many listed objects by incorporating a novel housing over the components of a C-frame motor. The housing can be constructed as a multi-piece or uni-body design depending on the design parameters. The housing is configured to allow for modular assembly of the motor to the housing.

In multi-piece form, the housing comprises a main housing body which encompasses the rotor/stator/bobbin assembly. An end-cap that envelopes an impeller attached to a motor shaft that is affixed to the rotor is configured to mate with the main housing body via snap-fit tabs or mechanical fasteners inserted into mating apertures provided in the main body housing and end-cap. In an alternate embodiment, the end-cap is configured to envelope the impeller and bobbin assembly.

The above and other features of the invention, including various novel details of construction and combinations of parts, will now be more particularly described with reference to the accompanying drawings and pointed out in the claims. It will be understood that the particular housing constructions embodying the invention are shown by way of illustration only and not as a limitation of the invention. The principles and features of this invention may be employed in various and numerous embodiments without departing from the scope of the invention.

### BRIEF DESCRIPTION OF THE DRAWINGS

FIG. 1 is a perspective view of a C-frame motor according to one embodiment of the invention.

FIG. 2 is a perspective end view of a C-frame motor according to one embodiment of the invention.

FIG. 3 is a sectional perspective view of a C-frame motor according to one embodiment of the invention.

FIG. 4 is a sectional perspective view of a C-frame motor according to one embodiment of the invention.

FIG. 5 is a perspective view of a C-frame motor according to one embodiment of the invention.

FIG. 6 is a perspective view of a C-frame motor according to one embodiment of the invention.

FIG. 7 is an exploded view of a C-frame motor with rotor aligned to stator via bearings housed in bearing sleeves according to one embodiment of the invention.

FIG. 7A is an exploded view of a C-frame motor with housing according to one embodiment of the invention.

FIG. 8 is a back end elevational view of a C-frame motor housing according to one embodiment of the invention.

FIG. 9 is a cross-sectional view of a back end mounting end plate according to one embodiment of the invention.

FIG. 10 is a partial cross-sectional view of a back end mounting plate and C-frame motor housing according to one embodiment of the invention.

FIG. 11 is a side elevational view of a front end mounting bracket according to one embodiment of the invention.

FIG. 12 is a top plan view of a front end mounting bracket according to one embodiment of the invention.

FIG. 13 is an end view of a front end mounting bracket according to one embodiment of the invention.

FIG. 14 is a perspective view of an end-cap/bobbin cap according to one embodiment of the invention.

### DETAILED DESCRIPTION OF THE INVENTION

A typical C-frame motor construction such as the two pole shaded pole motor shown in the drawings is comprised in its broadest aspect of a stator surrounding a rotor/rotor shaft assembly. The stator is comprised of a first stack of identically configured magnetically conductive laminations which have main bodies that define a rotor aperture for receiving a rotor. Each lamination has a pair of radially extended lamination extensions for receiving and securing a bobbin.

As suggested by the name, the shaded pole motor shown in the drawings has shading coils which function to produce starting torque and ultimately rotation of the rotor. Each lamination is provided with shading coil apertures for receiving electrical conductors made of copper or any other suitable electrically conductive material. The electrical conductors are fashioned into coils which encircle one of the two poles.

The laminations have further apertures for receiving mechanical fasteners that attach a first and second rotor bracket to the laminations. The brackets are configured to provide housings for a first and a second bearing which are in rotating communication with a rotor shaft such that the bearings allow for the free rotation of the rotor/shaft assembly. The rotor brackets align the rotor/rotor shaft assembly within the center of the lamination rotor apertures.

The lamination extensions are configured to receive a bobbin which is generally cylindrically shaped with a general circular cross-section and a centrally located bobbin aperture which matingly engages the lamination extensions. The bobbin is configured to receive electrical conductors such as copper wire in predetermined lengths and winding count. The bobbin is mated to the lamination extensions by inserting the lamination extensions into the bobbin aperture.

The bobbin is secured to the lamination extensions by a second stack of electrically conductive laminations that is comprised of approximately the same number of laminations as the first stack. Each lamination of the second stack has ends which matingly engage peripheral ends of the lamination extensions of the first stack. The bobbin is, in essence, trapped between the main bodies of the first stack laminations and main bodies of the second stack laminations.

The rotor is also comprised of a stack of electrically conductive laminations that are bound together with die cast aluminum bars and end rings. The rotor is affixed to a shaft that runs through aligned central shaft apertures defined by each rotor lamination.

The aforementioned description of a typical C-frame motor provides a modular approach to induction motor design that reduces the number of windings that are typically wound onto a stator and eliminates machinery that would otherwise be needed to provide windings on a stator.

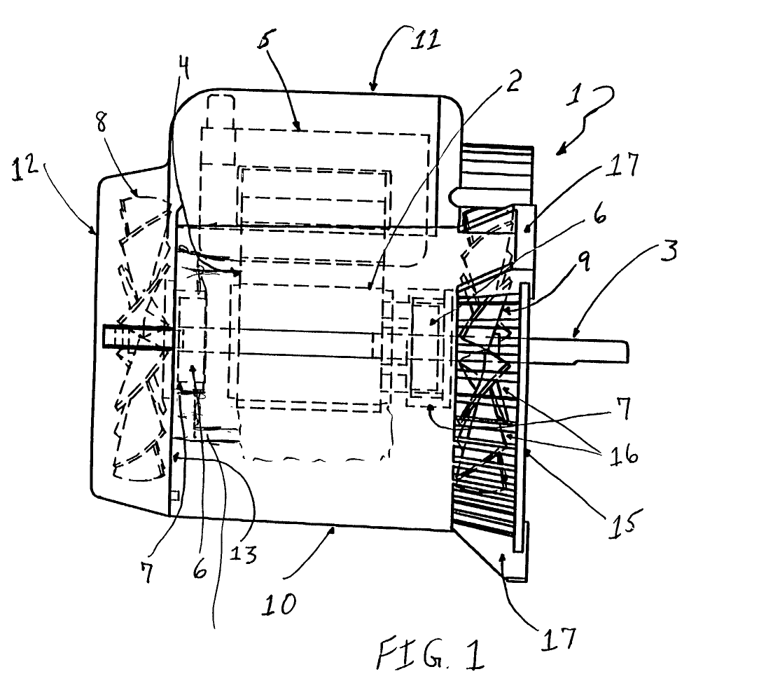

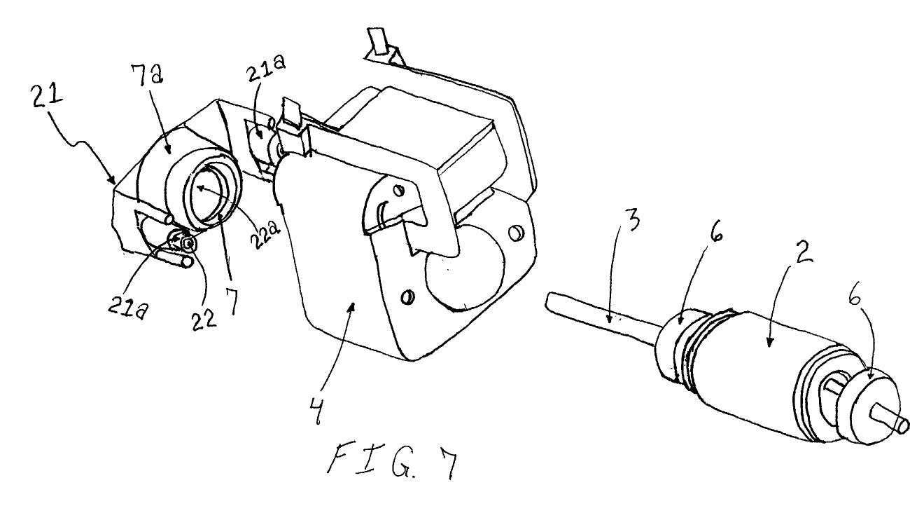

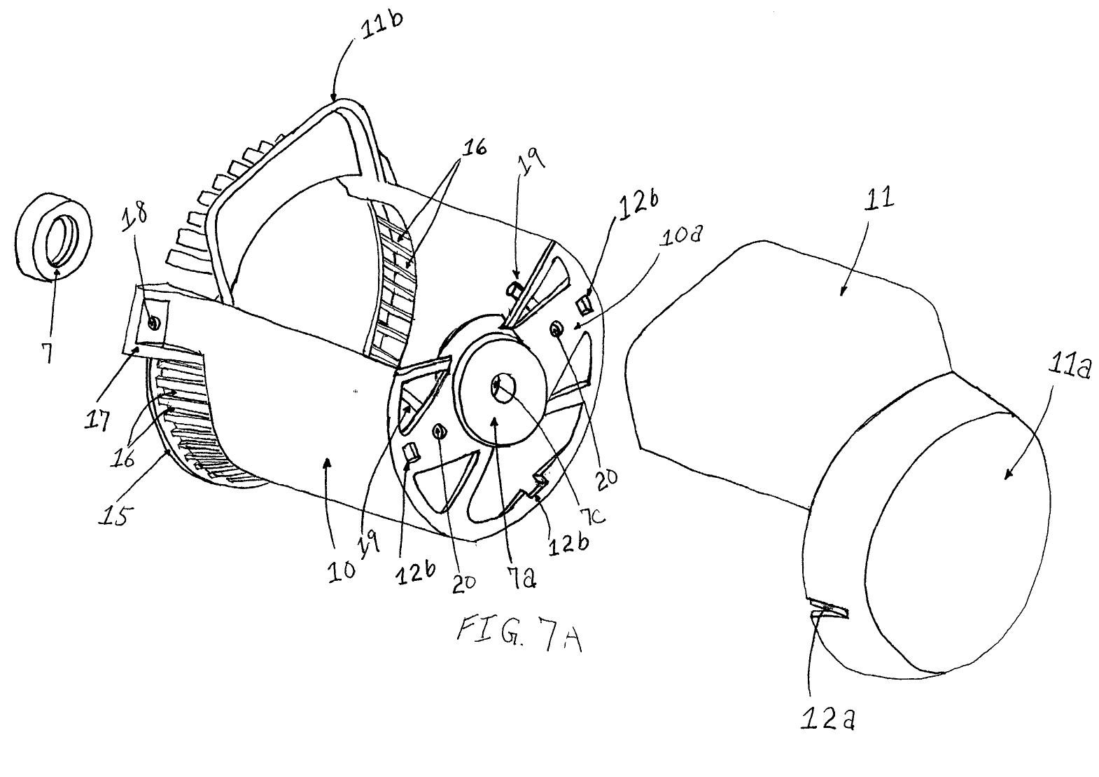

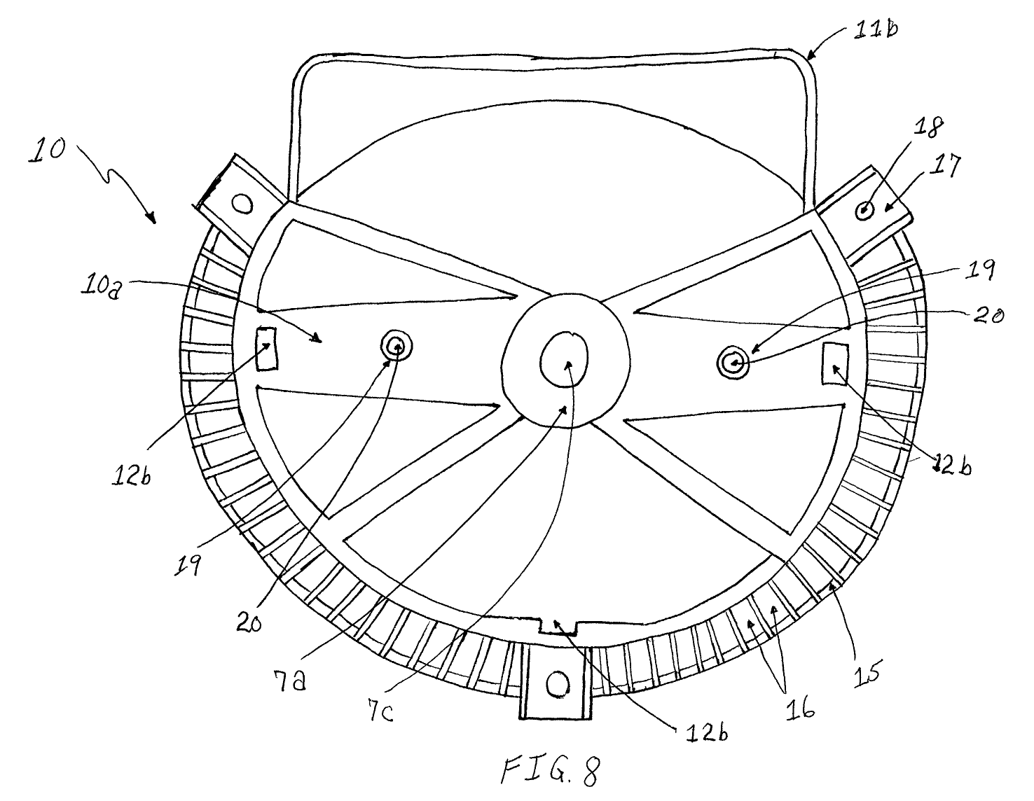

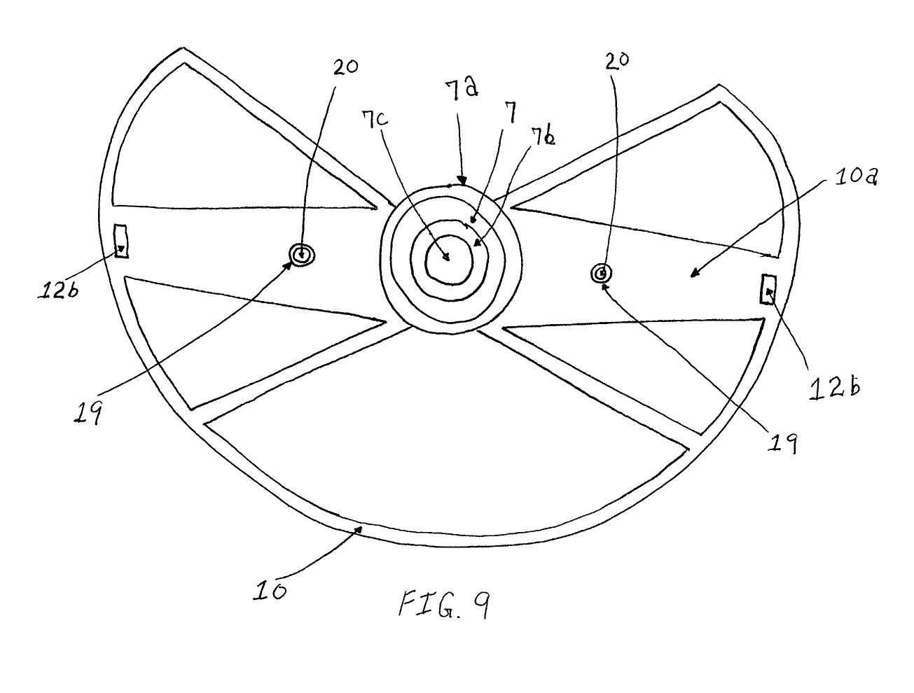

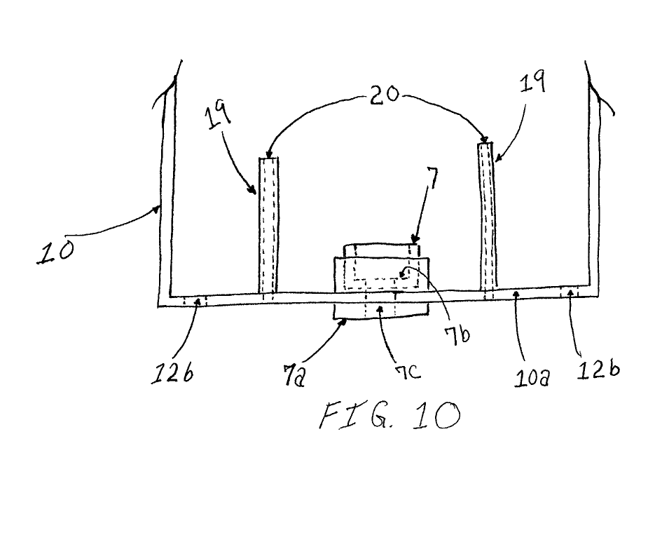

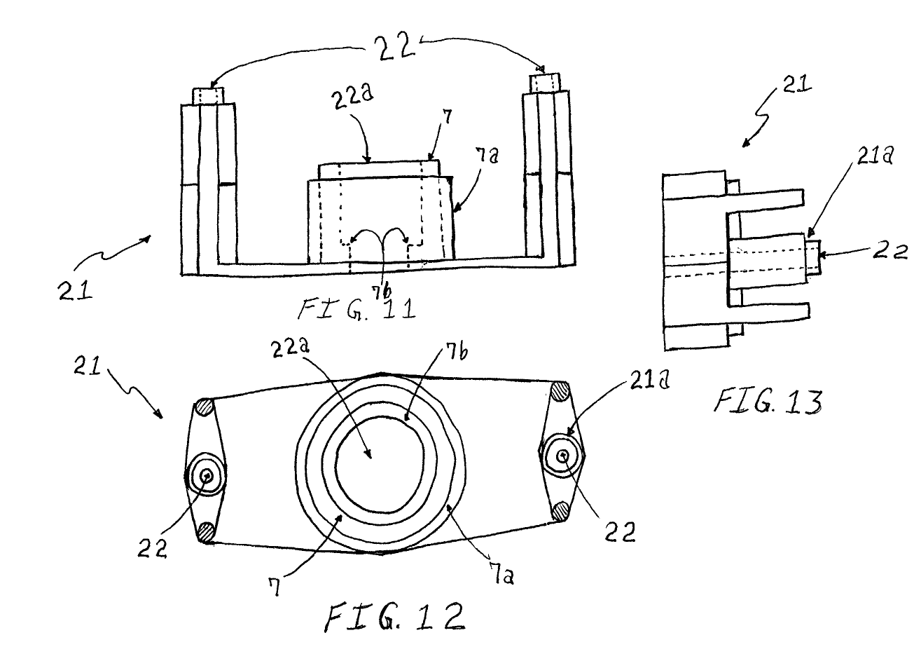

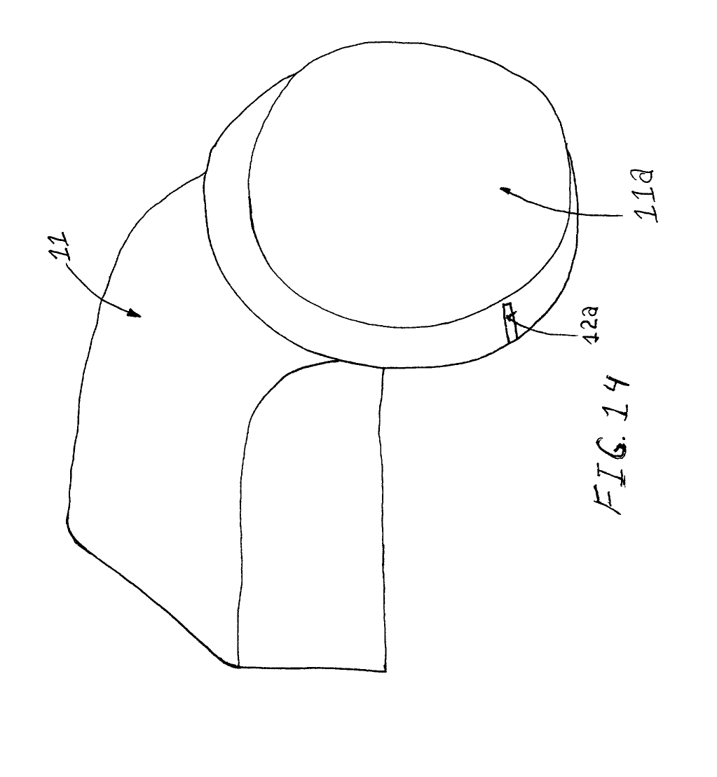

Referring now to FIG. 1, a standard two pole, shaded pole motor 1 is shown having a rotor 2, a rotor shaft 3, a stator 4 and a bobbin 5. The rotor is aligned within a rotor aperture (not shown) of stator 4 via bearings 6 which are housed in bearing sleeves 7. Bearing sleeves 7 are secured to bearing sleeve housings 7a as shown in FIG. 7. A posterior impeller 8 and an anterior impeller 9 are provided on opposite ends of rotor shaft 3 to draw cooling air transversally over the motor components.

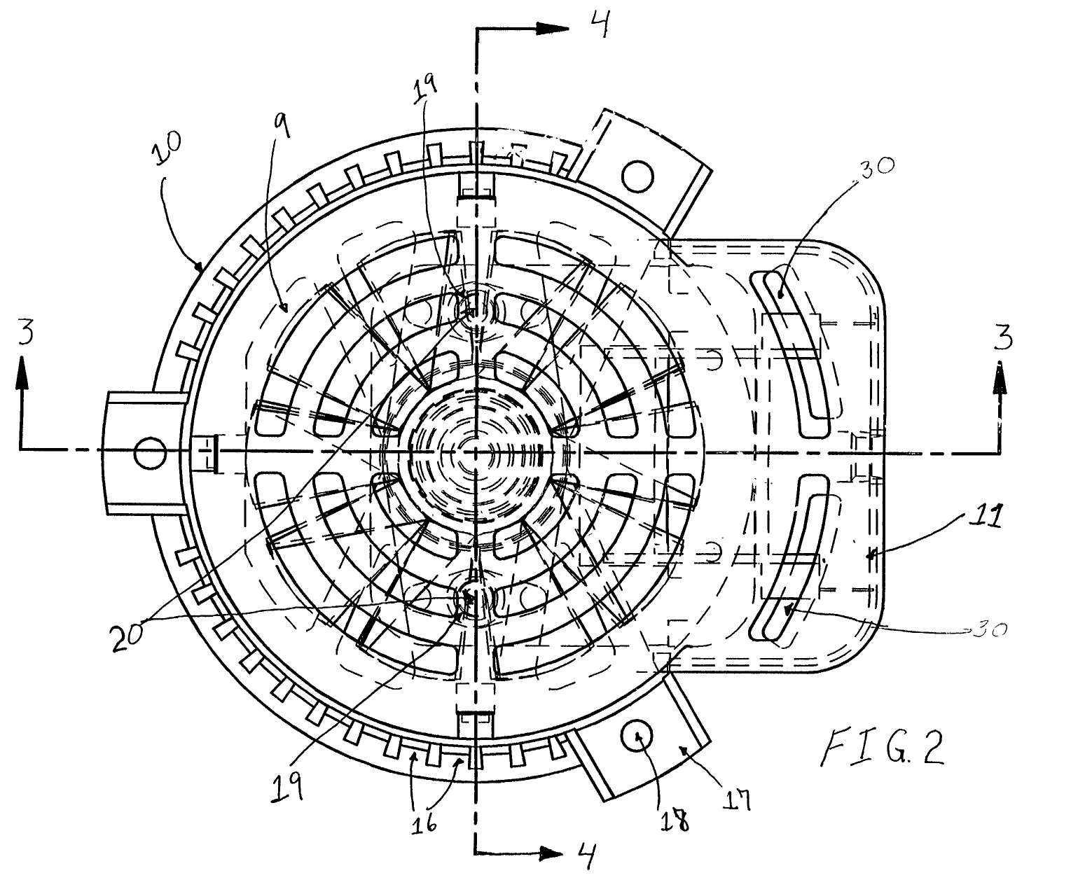

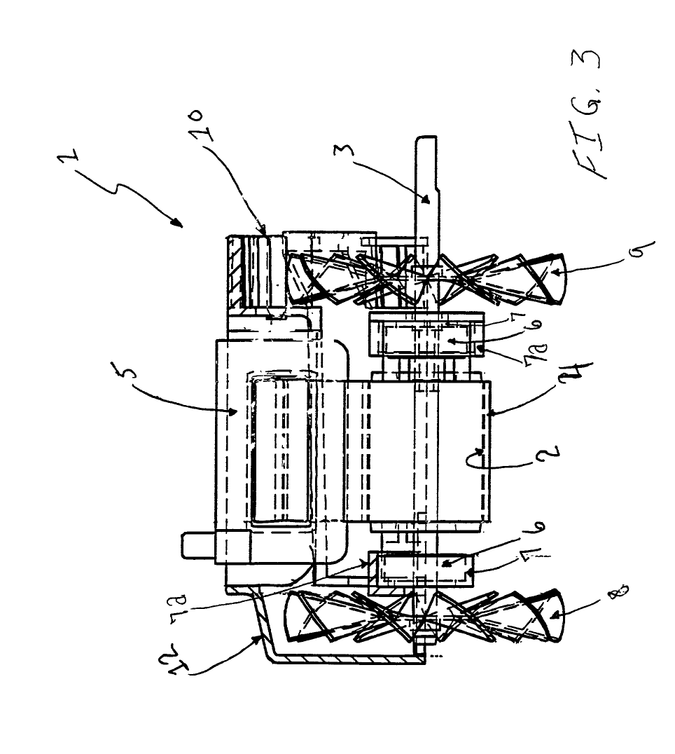

The entire stator/rotor/bobbin assembly is enshrouded in a main housing 10. Main housing 10 is generally circular in shape but can be shaped to conform to the generally square shape of the stator/rotor assembly. A radially extended projection 11 is provided to conform to the shape of the stator lamination extension/bobbin/second stator stack assembly. Optionally, projection 11 can be provided with vent bores or slots 30 as shown in FIG. 2. In an alternate embodiment as shown in FIGS. 7A and 14, extended projection 11 is part of an end-cap 11a which envelopes the bobbin assembly and impeller 8. When end-cap 11a is used, main housing 10 has a radially extended end-cap receiving portion 11b which is sized and configured to receive the bobbin-housing portion 11 of end-cap 11a.

Key to the function of the housing is the maintenance of an air gap between the housing and the motor assembly. In order for the housing to perform its intended cooling function, the gap between the housing and the motor assembly must be at least about 0.010 inches.

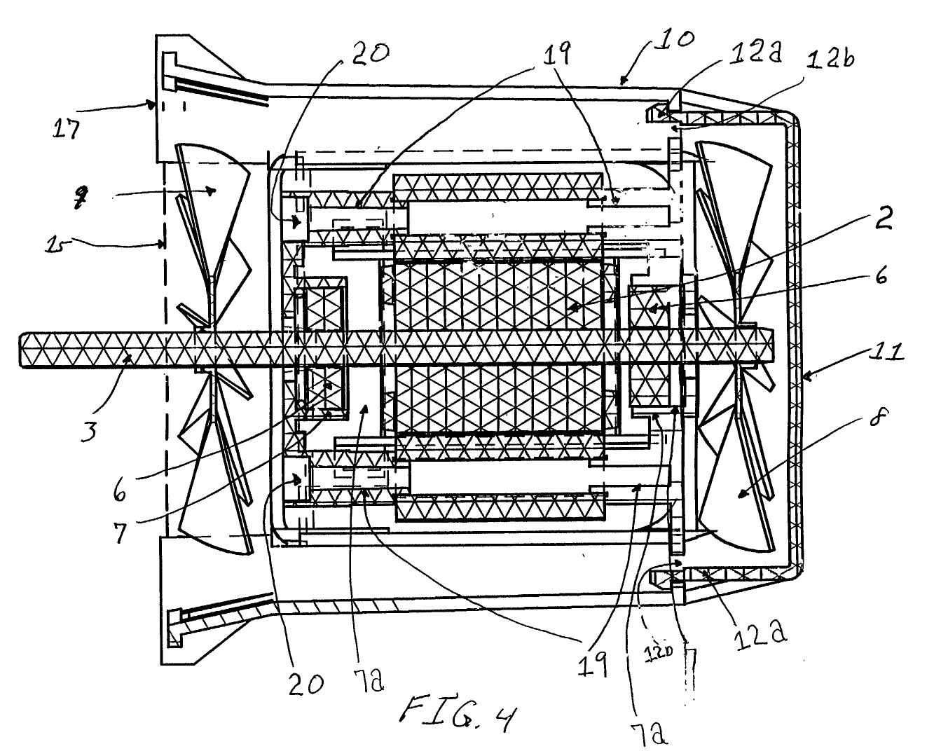

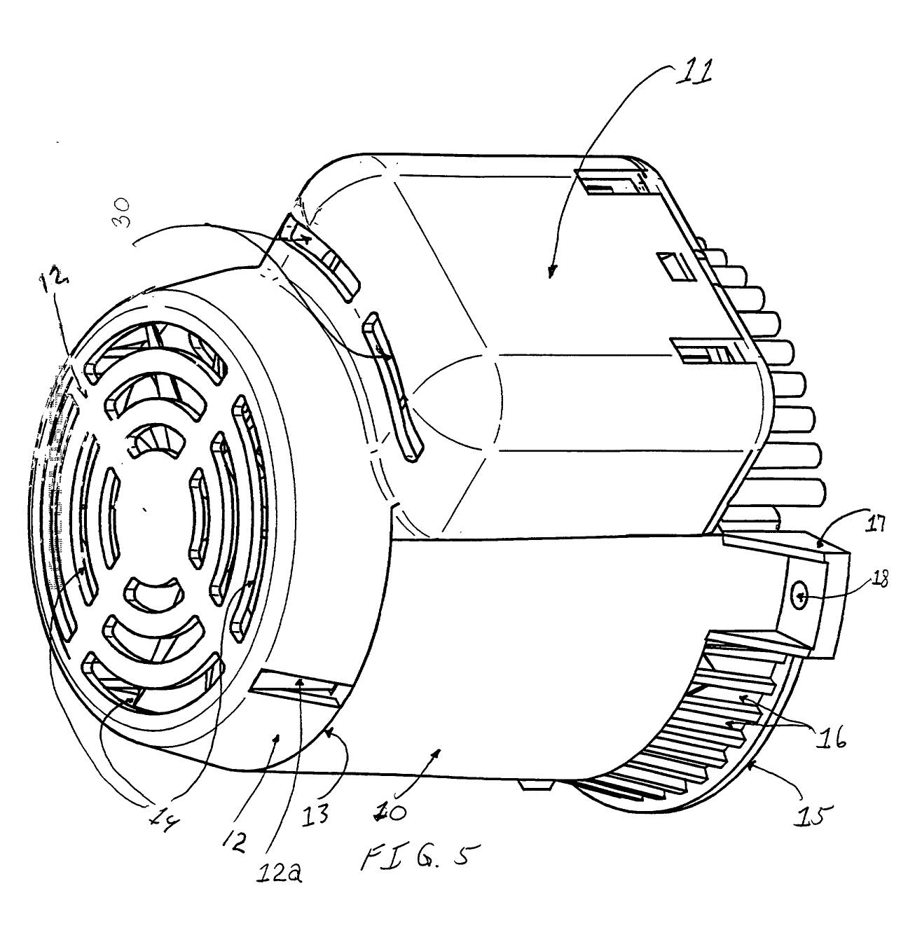

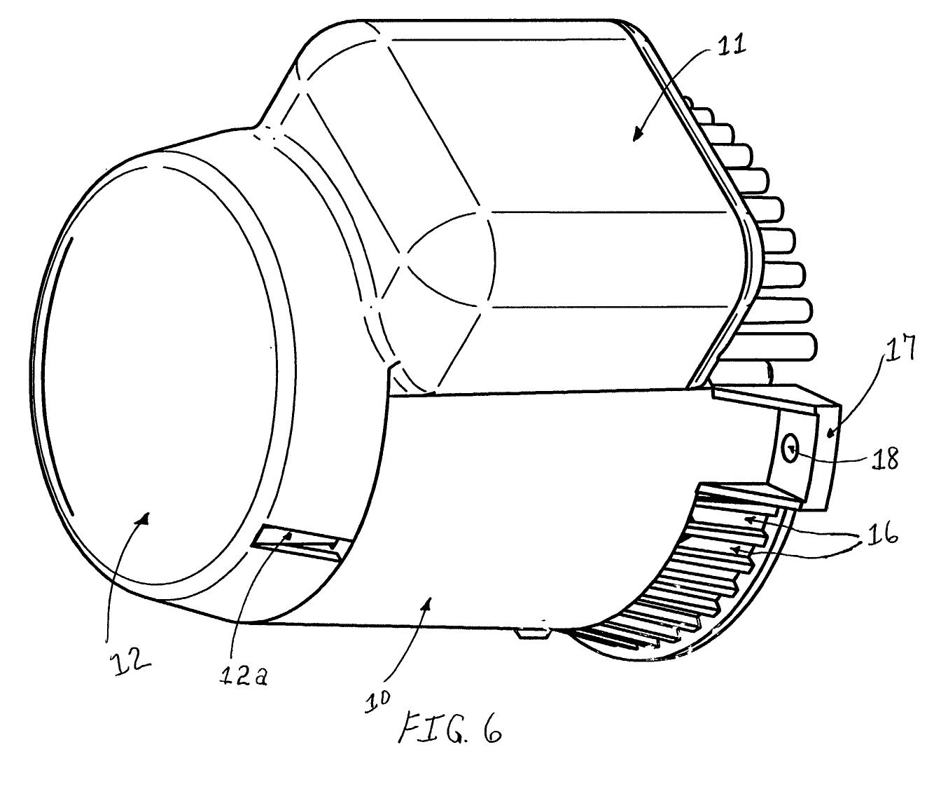

In one embodiment, an end housing 12 which is configured to conform to the shape of the posterior impeller 8 and is sized to allow for the free rotation of impeller 8 and to matingly engage a first end 13 of main housing 10. End housing 12 is attached to main housing 10 via bores and mechanical fasteners or male/female snap-fit tabs and apertures. As shown in FIGS. 4-8, end housing 12 and end-cap 11a are releasably engaged with main housing 10 via tabs 12a and tab apertures 12b. In one embodiment, end housing 12 is a solid enclosure that does not allow air to pass into the C-frame motor 1 from a posterior area of motor 1 as shown in FIG. 6. In another embodiment, end housing 12 defines a plurality of vent holes 14 which allow for the passage of external air into motor 1 from a posterior area of motor 1 as shown in FIG. 5.

Main housing 10 has an open second end 15 which is configured to conform to the shape of anterior impeller 9. Second end 15 has portions which define vent slots 16. Second end 15 has additional portions which define mounting tabs 17 which have apertures 18 (as shown in FIG. 2) for receiving mechanical fasteners (not shown) to secure motor 1 to a fixture such as a furnace.

The present invention incorporates a modular approach to the assembly of the stator/rotor/rotor shaft/bobbin/impellers assembly into the housing comprised of main housing 10 and end housing 12 or main housing 10 and end-cap 11a. Main housing 10 has portions which define parallel columns 19 which are oriented axially with main housing 10. Parallel columns 19 project axially from mounting end-plate 10a. Columns 19 define mounting apertures 20 which are sized to receive mechanical fasteners (not shown). Preferably, thread rolling screws are used as the mechanical fasteners.

As shown in FIGS. 1,3,4, 7 and 12-13, affixed to an anterior end of rotor shaft 3 is one of the bearings 6 which is rotatably secured within the anterior bearing sleeve 7. Bearing sleeves 7 have annular shoulders 7b which limit axial movement of rotor shaft 3. Anterior bearing sleeve 7 is housed within mounting bracket 21 which has portions which define annular sleeve housing 7a.

Mounting bracket 21 has posts 21a which have portions which define apertures 22 sized and positioned to align with mounting apertures 20. To secure the stator/rotor/rotor shaft/bobbin assembly to the housing, the assembly is placed into the housing from the anterior end of the housing so that the bobbin assembly is aligned with the aperture defined by main housing end-cap receiving portion 11b. Shaft 3 is received by a shaft receiving aperture 7c defined by portions of sleeve housing 7a. The stator/rotor assembly is slid into the housing so that apertures 4a defined by portions of stator 4 engage parallel columns 19 until the bearing 6/bearing sleeve 7 assembly comes into contact with posterior sleeve housing 7a situated in mounting end-plate 10a.

Following contact of end-plate 10a to the stator/rotor assembly, mounting bracket 22 which has portions defining a shaft receiving aperture 22a is positioned onto shaft 3 until anterior sleeve housing 7a comes into contact with the anterior bearing 6/bearing sleeve 7 assembly. Posts 21b also act as end-stops when they come into contact with stator 4. Mechanical fasteners, preferably of a self-threading variety, are then torqued into apertures 22 and mounting apertures 20. Alternatively, mounting apertures 20 and 22 can be pre-threaded to have a threading density that is matingly engageable with the threading of the selected mechanical fastener.

In accordance with the invention, the only point of contact between the housing assembly and the stator/rotor/rotor shaft/bobbin assembly is the end plate/parallel column contact point. It is essential that this be the only point of contact so that a relatively uniform curtain of air can be drawn via the impellers over the stator/rotor/bobbin assembly. In so constructing a C-frame motor, a number of benefits are realized.

First, in a typical construction, the bobbins of C-frame motors are covered with tape to protect the windings secured to the bobbins from the damaging effects of the environment and to insulate the windings from the inevitable heat buildup that occurs with motor operation. By incorporating the housing of the present invention, the need for taping the bobbin windings is eliminated.

A second benefit of the present invention is results from the ability to direct cool air over the components of the motor. In a C-frame motor that does not incorporate the novel features of the invention, any air that is drawn towards the motor by the impellers is quickly dissipated since the air is not subject to any physical constraints. This results in inefficient cooling and premature motor wear. By incorporating the housing of the present invention, cool air can be drawn into the housing where it is concentrated to flow over the motor components to allow for greater heat dissipation. By lowering the operating temperature of the motor, motor longevity is increased and the capacity to make stronger motors with the same size stator and rotor stacks is realized.

A third benefit of the C-frame motor housing relates to safety. Motor operation within the housing creates a layer of air that surrounds the motor without touching it. This enables the housing to remain at or near ambient temperature so that it is cool to the touch. A conventional C-frame motor cannot be grasped until a cool down period has been instituted after motor shutdown. Accordingly, motor servicing is made more efficient.

A fourth benefit relates to manufacturability. Addition of a housing does add to material costs but is offset by savings realized in eliminating the bobbin taping and taping application step in the manufacturing process. Production of C-frame motors with the novel housing has a negligible effect on increasing the number of manufacturing steps due to the modular design.

While representative embodiments have been shown for the purpose of illustrating the invention, it will be apparent to one skilled in the relevant art that changes and modifications can be made without departing from the spirit and scope of the invention. For example, the motor housing can be configured to accommodate motors having a plurality of poles or bobbins.

Having thus described our invention, what we claim as new and desire to secure by United States Letters Patent is:

1. A C-frame motor comprising:
a stator having a plurality of electrically conductive laminations wherein said laminations have portions which define rotor apertures for receiving a rotor and portions which define radially extended projections for receiving a bobbin;
a rotor having a plurality of laminations and sized to be received within said rotor apertures of said stator laminations;
at least one bobbin having a plurality of coils comprising at least one wound electrical conductor wherein said at least one bobbin is attached to said stator lamination projections; and,
a housing configured to encompass said stator, said rotor and said at least one bobbin wherein said housing is attached to said stator.

2. The C-frame motor of claim 1, wherein said housing comprises a main housing body and an end cap.

3. The C-frame motor of claim 2, wherein the end cap has vent slots.

4. The C-frame motor of claim 1, further comprising an end plate, said end plate configured and adapted to attach to said stator wherein said end plate has apertures for receiving mechanical fasteners.

5. The C-frame motor of claim 4, wherein said housing has portions defining at least one attachment in axial relationship with said housing body.

6. The C-frame motor of claim 5, wherein said housing is attached to said end plate with mechanical fasteners.

7. The C-frame motor of claim 1, further comprising at least one impeller.

8. The C-frame motor of claim 7, wherein said housing has a first end configured -to encompass said at least one impeller such that said impeller can freely rotate within said housing.

9. The C-frame motor of claim 8, wherein said housing first end has portions defining vent slots.

10. The C-frame motor of claim 1, wherein said housing has portions defining a bobbin extension extending radially from said housing and sized to encompass said at least one bobbin.

11. A C-frame motor comprising:
a stator having a plurality of electrically conductive laminations wherein said laminations have portions which define rotor apertures for receiving a rotor and portions which define radially extended projections for receiving a bobbin;
a rotor having a plurality of laminations and sized to be received within said rotor apertures of said stator laminations;
at least one bobbin having a plurality of coils comprising at least one wound electrical conductor wherein said at least one bobbin is attached to said stator lamination projections;
a housing configured to encompass said stator, said rotor and said at least one bobbin wherein said housing is attached to said stator, and wherein said housing comprises a main housing and an end housing.

12. The C-frame motor of claim 11, wherein said main housing has a radially extended projection provided to conform to the shape of said stator, said rotor, and said at least one bobbin.

13. The C-frame motor of claim 11, wherein said radially extended projection has vent slots.

14. The C-frame motor of claim 11, further comprising at least one impeller.

15. The C-frame motor of claim 14 wherein said end housing is configured to conform to the shape of said at least one impeller.

16. The C-frame motor of claim 11, wherein said end housing is matingly engaged to a first end of said main housing.

17. The C-frame motor of claim 11, wherein said end housing includes a plurality of vent holes.

18. The C-frame motor of claim 11, wherein said end housing is a solid enclosure.

19. A method of enclosing a C-frame motor comprising the steps of:
providing a motor assembly having a stator, a rotor and at least one bobbin having electrical conductor windings situated thereon;
providing an end plate wherein said end plate is adapted to attach to said stator;
providing a motor housing having portions configured to encompass said motor wherein said housing is attached to said motor via attachment to said end plate; and,
securing said housing to said end plate.

20. The method of claim 19, including the step of providing said housing with a radially extended portion adapted to enclose said at least one bobbin.

21. The method of claim 19, including the steps of providing an impeller and providing a rotor shaft attached to said rotor whereby rotation of said rotor shaft rotates said impeller.

22. The method of claim 21, including the step of providing an end cap adapted to encompass said impeller such that said impeller can freely rotate within said end cap.

23. The method of claim 22, including the step of rotating said impeller to induce air flow over said motor.

24. The method of claim 19, further including the step of maintaining an air gap of at least 0.010 inches between said housing and said motor assembly.

25. The method of claim 19, further including the step of securing said motor assembly to said housing by placing said motor assembly into said housing from an anterior end of said housing so that said motor assembly is aligned with the aperture defined by a main housing end-cap receiving portion.
